(19) United States
(12) Patent Application Publication
(10) Pub. No.: US 2011/0189646 A1
(43) Pub. Date: Aug. 4, 2011

(54) Pedagogical system method and apparatus

(76) Inventor: Amos Benninga, Arlington, MA (US)

(21) Appl. No.: 12/931,393

(22) Filed: Jan. 31, 2011

Related U.S. Application Data
(60) Provisional application No. 61/337,256, filed on Feb. 1, 2010.

(51) Int. Cl. G09B 5/00

(52) U.S. Cl. 434/350

(57) ABSTRACT

An interactive educational system is adapted to receive training materials, modules and facilities from a plurality of contributors and present an integrated educational experience to a student.

### CROSS-REFERENCE TO RELATED APPLICATIONS

The present application claims the benefit of U.S. provisional patent application Ser. No. 61/337,256 filed on Feb. 1, 2010 the disclosure of which is herewith incorporated by reference in its entirety.

### FIELD OF THE INVENTION

The present invention relates to pedagogical apparatus and more specifically to a pedagogical system and components for integrating and presenting teaching materials from multiple sources.

### BACKGROUND

It is beyond dispute that the history of pedagogical tools and devices is almost as old as teaching itself. Whatever the origins of such tools, it is well known that wax tablets, paper and blackboards were long used in the instruction of students in various topics. With the more recent development of electrical and electronic apparatus, the range of technological support available to a teacher has expanded to include filmstrips and slide shows, movies and video tapes. Subsequently, an explosion in the availability of computer processors and related equipment has provided far more extensive access to locally stored information and to remotely stored information received by modern communication means.

This sudden growth in the platforms and mechanisms available for the development of tools to support teaching and learning has been matched by a corresponding expansion in the efforts of teachers, and content developers, to apply and employ technology to advance teaching. Huge resources have been devoted to such development and notable progress has been achieved.

This expenditure of effort and resources is reflected in the development of various pedagogical tools and systems illustrated, for example, in the disclosures of certain US patents, the disclosures of each being herewith incorporated by reference in its entirety. For example, U.S. Pat. No. 7,299,188 relates to a method and apparatus for providing an interactive language tutor; U.S. Pat. No. 7,270,546 relates to a system and method for interactive reading and language instruction; U.S. Pat. No. 7,149,690 relates to a method and apparatus for interactive language instruction; U.S. Pat. No. 6,499,013 relates to an interactive user interface using speech recognition and natural language; U.S. Pat. No. 6,435,876 relates to the interactive learning of a foreign language; U.S. Pat. No. 6,358,053 relates to interactive online language instruction; U.S. Pat. No. 6,305,942 relates to a method and apparatus for increased language fluency through interactive comprehension, recognition and generation of sounds, words and sentences; U.S. Pat. No. 6,017,219 relates to a system and method for interactive reading and language instruction; U.S. Pat. No. 5,885,083 relates to a system and method for multimodal interactive speech and language training; U.S. Pat. No. 5,810,599 relates to an interactive audio-visual foreign language skills maintenance system and method; U.S. Pat. No. 5,766,015 relates to apparatus for interactive language learning; U.S. Pat. No. 5,634,086 relates to a method and apparatus for voice-interactive language instruction; and U.S. Pat. No. 5,010,495 relates to an interactive language learning system.

Notwithstanding the advances and developments represented by these documents, various important problems have heretofore remained unresolved. Consequently, it is understood that well known needs and long-standing requirements remain unaddressed and that problems known to many stand unresolved.

The inventor and present applicant, having carefully considered the state of the existing art, the effort devoted to seeking solutions, and the many problems that nevertheless remain unresolved, has now drawn new and important conclusions. On the basis of these novel and nonobvious conclusions, the following developments discoveries and inventions have been prepared.

### SUMMARY

The invention presented here relates to a method and apparatus for education & language instruction. More specifically, the invention is directed to a multi-media multi-modal computer application that provides features and functions for interactive learning and non-interactive learning, for online as well as offline learning. The invention includes features to record and store the progress of a student and to provide feedback regarding progress in learning.

A system according to principles of the invention includes collaborative functions and tools for creating lessons, courses and other educational material as well as functions for collaborative content creation and sharing. The invention enables teachers and content providers to create new methods and formats for delivering educational and language content and the means to publish, promote and sell content.

As will be readily understood upon review of the following disclosure the devices and methods of the invention optionally include various functional aspects and details. For example, in one aspect, the invention includes a student data module configured to store and collect student specific information, lessons and courses bought, acquired, received, and taken, exercises started and finished, scores of exercises, lessons and courses, words and phrases seen and learned, evaluated current levels and predicted future levels.

In a further aspect of the invention, the system includes a module configured to enable creation of new applications and exercises for content authoring, display formats, and interactive activities. The module can further support the publishing, revising, editing and selling of such applications and exercises. The module can also support searching, filtering and browsing existing applications, exercises, lessons and courses.

In a still further aspect, the invention includes features to provide capability to create applications and exercises, the ability to submit, modify, save, remove and review application and exercises.

In a further aspect, the invention includes a dictionary of words, translations from one language to another, word synonyms, idioms and explanations. The system can further provide the ability to add, remove, change, rate and comment on elements within the built in dictionary. The system can also provide the ability to extend the dictionary functionality by users to provide new type of dictionary content (such as word to image mapping, etc.).

In one aspect of the invention, the system provides the ability for application creators and content creators to review and use their content as if they were students for testing purposes.

In one aspect of the invention, the system includes a module configured to enable creation of new educational content, including exercises, lessons, courses, texts, images and pictures, instructions and guidance. The module can further support the publishing, revising, editing and selling of such educational content. The module can further support searching, filtering and browsing of existing exercises, lessons and courses, learning topics and sub-topics.

In one aspect of the invention, the system includes a module configured to provide cross-lesson, cross courses functionality such as dictionaries, learning history, learning areas of progress and learning areas of difficulties for a student. The module can further supports the extensions of the basic functionality by users of the system through different mechanisms such as application programming interface (API), graphical and textual tools extension creation, re-configuration of existing functionality and similar approaches.

In one aspect, the invention includes a module for registering, managing, removing, and adding of students, teachers, application creators and other users. The module can further support security access control to monitor, restrict, hide, expose, and enable the operations available, the information and content that can be read, accessed and/or used by different users. The module can further support changes to permissions based on global system configuration, purchases of content and applications made by users, price and other policies (such as age restrictions) set by content providers (lesson and application creators), and user preferences.

In a still further aspect, the invention includes a module for taking lessons and courses, doing exercises, reading texts, viewing pictures and images, reviewing status of exercises, lessons and courses, saving progress, and resuming activities.

In another aspect of the invention, the system can enable the user to print certain exercises, lessons and courses to create non-interactive learning material.

In an additional aspect the invention provides search and filtering capabilities to let students find lessons, courses and other learning material based on topic, area of interest, keywords, content rating, and system recommendations.

In one aspect of the invention, the system can provide rating capabilities to rate learning material, applications, exercises, lessons, courses, content providers (such as teachers, professionals and other entities creating content) and other elements within the system. The system can also allow associating rating with relevant items, to display rating and to use the rating for filtering, searching and promotion of content.

In one aspect of the invention, the system can provide functionality to add comments to learning material, applications, exercises, lessons courses and to rating items and other elements within the system. The system can further provide the ability to view, edit, remove, add comments, reply to comments, and search for content by comments.

In one aspect of the invention, the system can provide the ability to download all required content and artifacts to a local computer, device, machine for offline usage (without Internet connection). The system can provide the ability to synchronize all activities and changes done offline with an online repository and other offline content.

In one aspect of the invention, the system can provide the ability to access content, exercises, status and other system features through the usage of Internet capable computers, devices and machines.

In light of the foregoing, an exemplary embodiment of the invention includes a pedagogical exchange system having various functional components including a student user interface machine, a storage machine and a management system. In certain embodiments, the student user interface machine is adapted to receive from a remote storage device a previously prepared pedagogical presentation. The pedagogical presentation is received at the student user interface machine responsive to a student selection. In certain embodiments, the pedagogical presentation is selected by the student from a plurality of possible pedagogical presentations.

The storage machine includes the above-noted remote storage device and is adapted and arranged to store and reproduce an encoded portion of the pedagogical presentation. The storage machine is further adapted to receive and store, from a respective plurality of independent developers, respective encoded portions of the plurality of possible pedagogical presentations.

In certain aspects and embodiments of the invention, the management system noted above includes the storage machine. According to principles of the invention, the management system is adapted to configure a machine readable medium of the storage machine to represent an encoded record related to the student selection.

According to further principles of the invention, the interface machine and the storage machine each include a respective programmable processing device and a respective memory device. In certain aspects of the invention, the respective memory devices are adapted to operate so as to undergo a measurable transformative physical reconfiguration, i.e., a transformation of matter. Consequently the encoded portion of the pedagogical presentation is stored as a measurable physical state of the memory device.

The invention is aimed at the general art of interactive education learning and can be applied to specific areas such as language learning, mathematics learning, and literature learning. While the invention will be described with specific reference to several exemplary embodiments, primarily related to language study, it will be appreciated that the invention has usefulness in other areas such as music study, history study and other such applications. Accordingly, embodiments of the invention (including a preferred embodiment) are given by way of illustration only, since various changes and modifications within the spirit and scope of the invention will become apparent to those skilled in the art.

### BRIEF DESCRIPTION OF THE DRAWINGS

FIG. 1 shows, in schematic representation, a plurality of system elements in mutual communication according to certain aspects of the invention;

FIG. 2 shows, in schematic block diagram form, a representation of certain client device functionality according to aspects of the invention;

FIG. 3 shows, in schematic block diagram form, a representation of certain server device functionality according to aspects of the invention;

FIG. 4 shows, in flow chart format, an overview of certain application development processes according to aspects of the invention;

FIG. 5 shows, in flow chart format, an overview of certain methods and processes for the creation of pedagogical content according to certain aspects of the invention;

FIG. 6 shows, in flow chart format, a process and method for creating a course according to certain aspects of the invention;

FIG. 7 shows, in flow chart format, a portion of a course selection process according to certain aspects of the invention;

FIG. 8 shows, in flow chart format, a portion of a process for lesson acquisition according to certain aspects of the invention;

FIG. 9 shows, in flow chart format, a portion of a process for platform extension according to certain aspects of the invention;

FIG. 10 shows, in flow chart format, a portion of an off-line operation process according to certain aspects of the invention;

FIG. 11 shows, in flow chart format, a portion of a process for the printing of certain information according to aspects of the invention;

FIG. 12 shows, in flow chart format, a portion of a progress report functionality according to certain aspects of the invention;

FIG. 13 shows, in block diagram form, a pedagogical library module according to certain aspects of the invention;

FIG. 14 shows, in block diagram form, a pedagogy evaluation module according to certain aspects of the invention;

FIG. 15 shows, in block diagram form, a bursar module according to certain aspects of the invention;

FIG. 16 shows, in block diagram form, a dictionary module according to certain aspects of the invention; and

FIG. 17 shows, in block diagram form, an integration management module according to certain aspects of the invention.

### DETAILED DESCRIPTION

The following description is provided to enable any person skilled in the art to make and use the disclosed invention and sets forth the best modes presently contemplated by the inventors of carrying out their invention. In the following description, for purposes of explanation, numerous specific details are set forth in order to provide a thorough understanding of the present invention. It will be apparent to one skilled in the art, however, that the present invention may be practiced without these specific details. In other instances, well-known structures and devices are shown in block diagram form in order to avoid unnecessarily obscuring the invention.

The invention includes, in various aspects, systems, methods and apparatus to allow the learning of language, and other topics, by students (in some cases in geographically separate locations) using pedagogical materials provided in a variety of configurations and by a variety of teachers and materials developers. The systems, methods and apparatus of the invention allow different teachers and developers to prepare teaching materials in a wide variety of formats, and to integrate these materials with the system and with other teaching materials on the system in an inter-operative fashion. Consequently, an exemplary system according to the present invention includes apparatus structured to provide an environment for integrated pedagogical presentation of diverse instructional materials.

In one aspect of the invention, a processing machine includes a processor, a memory unit, a communication device and a storage device. The storage device includes a computer readable medium. The computer readable medium has a plurality of switching structures configured to encode pedagogical course material from multiple course material creators. In addition, the plurality of switching structures is encoded to represent various transaction mechanisms stored in functional modules as further described and illustrated below.

Using the methods of the invention, this apparatus can be configured to educate students in various locations using a wide variety of interface devices. Equally importantly, the apparatus can be configured to receive instructional materials from a wide variety of sources and origins. According to various aspects of the invention, instructional materials having different sources and origins can be presented for pedagogical purposes in a coherent and coordinated manner so as to form a consistent pedagogical presentation.

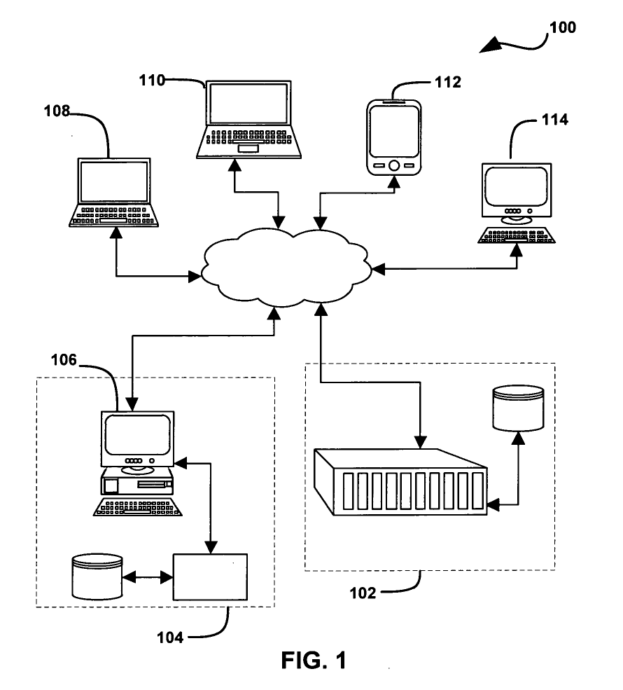

FIG. 1 shows, in schematic form, a multi-node system 100 including a plurality of processing and communication devices. In a certain aspect of the invention, the communication devices are adapted to communicate information such as language instruction information from a server device 102 to a presentation client device 104. In a further aspect of the invention, the communication apparatus is adapted to communicate responsive information from the presentation client device 104 to the server device 102.

It should be noted that the characterization of devices as “server” and “client” is made as a matter of convenience and represents one arrangement in which a system according to the invention can be configured. A wide variety of other arrangements are possible, as will be discussed below in additional detail. In particular, it should be noted that any logical “server” device may include a plurality of computing and data storage devices arranged to mutually provide a “cloud computing” service.

The invention is conceived to include a wide variety of presentation client devices, several examples of which are shown in FIG. 1. Thus, a pedagogical presentation according to the invention can be received by a student on a desktop computer 106, a netbook computer 108, a notebook computer 110, a personal digital assistant or tablet computer 112, a terminal device 114, or any other communication device appropriate to the requirements of the system.

It should be understood that the presentation client devices, servers and other corresponding devices, as well as the communications devices and services of FIG. 1 are equally well employed by other parties including content developers and system managers. Accordingly, for example, it is contemplated that one or more, up to and including a large number and variety of, content developers will have access to the system of the invention by means of any of the illustrated modalities.

This access allows content developers to receive various existing portions of the system and modify such portions, as well as to develop new portions and content for the system. Such modified, and newly developed, content is uploadable to the system for subsequent execution and consumption by students, teachers, and other consumers. It is contemplated that developer access will be open to developers according to the terms of a particular embodiment of the system, and that a wide variety of embodiments are possible. Thus content developers may develop content for various types of monetary and non-monetary consideration. Content developers may receive compensation on a per-module basis, on a per-consumption basis, or on any other basis appropriate to a particular use and application of the system. Moreover, the terms of a particular embodiment may be dynamic and modifiable over time.

According to certain aspects of the invention, the communication apparatus includes various public or common carrier communication apparatus. For example, the apparatus may include common carrier data channels such as optical fiber data channels, coaxial cable data channels, and wireless data channels of various configurations such as are known, or may become known, in the art. According to certain further aspects of the invention, the communication apparatus includes aspects of a network such as the “Internet,” and communication protocols, together constituting aspects of the “World Wide Web.”

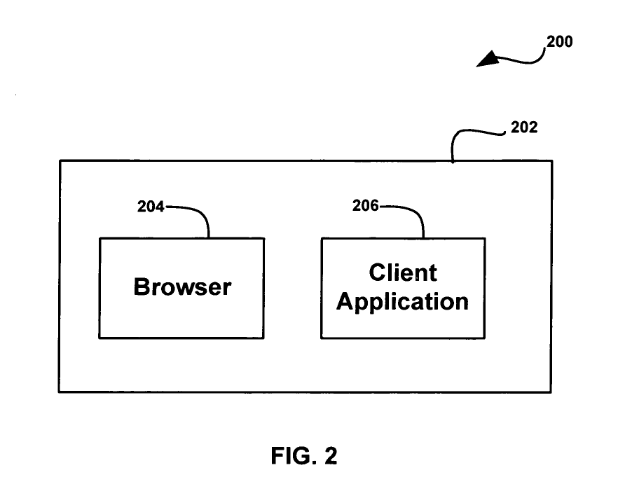

According to certain aspects, the invention includes automatic processing equipment adapted to perform particular functions including communications functions, processing functions and storage functions. The automatic processing equipment embodies particular machines including, for example, special-purpose machines and general-purpose machines rendered special-purpose by virtue of the particular devices contained therewithin, as well as by the physical states of such devices and the measurable physical transformations of such states. Accordingly, certain processing machines within the physical apparatus of the invention are configured to perform particular functional activities and processes. Exemplary aspects of these functional activities and processes will now be described in overview with respect to FIG. 2.

FIG. 2 shows, in schematic block diagram form, certain functional aspects 200 of a system according to principles of the invention. As illustrated, these functional aspects 200 of the system reflect the operation of a presentation client device 202. As noted above, in certain aspects the presentation client devices a computerized apparatus or system. In certain embodiments of the invention, the presentation client device 202 includes one or more input/output devices such as a keyboard, mouse, microphone, display screen an audio speaker. Many such input/output devices are known to one of skill in the art, and others that will be readily applied and operated within the scope of the invention are anticipated.

According to certain embodiments of the invention, functional aspects 200 of the system are operated within the presentation client device 202 including a browser functional module 204 and a student client application functional module 206. As one of skill in the art will understand, these functional modules represent distinct and specialized physical encoding states of devices within the presentation client device 202.

As is commonly understood, a variety of browser applications providing communications and access to remote functionality are available. Thus browser functional module 204 may include, in certain embodiments of the invention, a web browser such as Microsoft Internet Explorer™, Mozilla Firefox™ and Google Chrome™, for example.

The student client application functional module 206 provides the communications and access remote functionality of a browser functional module 204 in certain embodiments. In other embodiments, the student client application functional module 206 provides functionality adapted to operate in conjunction with a browser functional module 204. Accordingly, in certain embodiments, functional results generated by the student client application functional module 206 are transmitted to one or more remote devices by way of the browser functional module 204.

The presentation client device 202, in certain aspects, includes various environment and support functionality such as operating system functionality. It is to be further appreciated that the presentation client device 202 may also be incorporated in and/or compatible with client-server and slim client architectures. It is to be further appreciated that such system functionality may be received through, for example, a compact disk, an Internet connection or other communications interface, and may be downloadable to a smaller, more mobile, device.

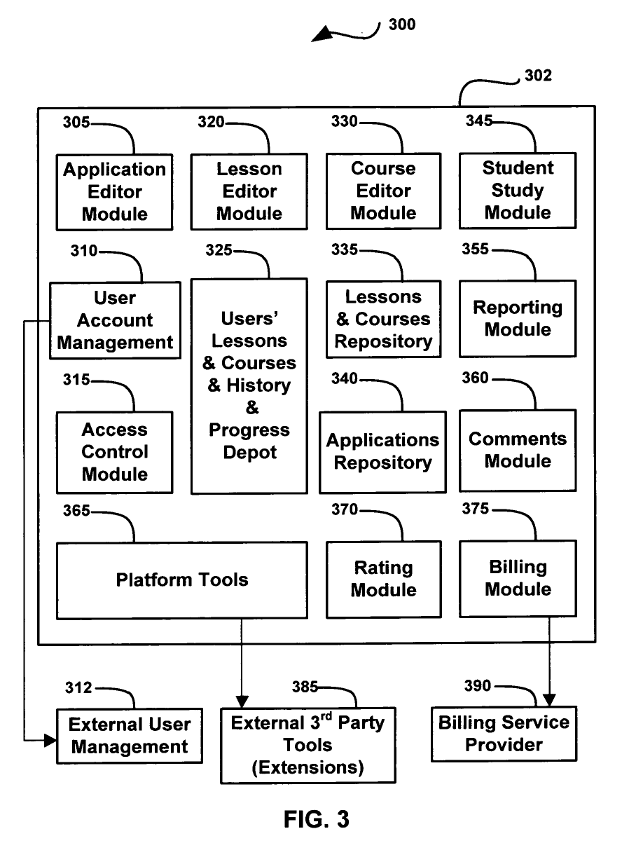

According to principles of the invention, the presentation client device is adapted to communicate with further functional aspects of the system as illustrated, for example, in FIG. 3.

FIG. 3 shows certain aspects of a system 300 according to the invention. In the illustrated embodiment, functional modules of system 300 are shown as disposed within an integrated environment or server apparatus 302. It will be appreciated, however, that alternative arrangements and distributions of functional modules are equally contemplated. Thus the functional modules of system 300 can be remotely located with respect to one another and with respect to functional modules of the system 200, and accessible over a network or other connection in accordance with the present invention.

Exemplary system 300 includes a study module 345. The study module 345 prepares, organizes and facilitates the interactions of the student with the system. A user can take lessons and exercises through the study module 345, as well as view lesson scores and exercise scores. The user can browse lessons and courses, search, find and buy new lessons and courses. The user interactions with study module 345 are given here for illustration and it is understood that additional interactions exist and can be added.

In certain embodiments, the study module 345 provides study materials through various channels such as a browser system 204 or a client application 206. The student study module 345 interacts with other system modules in order to load, store and manipulate educational and language content. In certain aspects of the invention the study module 345 receives lessons and courses from a lesson and courses repository module 335. In other aspects of the invention the study module 345 receives student information from a history and progress module 325 and saves updated information into the history and progress module 325.

The study module can also interact with other system modules such as an access control module 315, a billing module 375, a comments module 360 and a rating module 370. For example, a user can provide comments and rate a lesson using the comments module 360 and the rating module 370.

As shown, certain embodiments of the invention include a system 300 with a reporting module 355. The reporting module provides general information about usage and progress to users of the system including students, teachers, content providers, etc. The reporting module interacts with other system modules such as the history & progress module 325, the billing module 375, the application repository 340, and the rating module 370, among others.

The reporting module 355 provides a student with a report including information such as, for example, the number of lessons completed and the average score across lessons. Such reporting capability provides, advantageously, the ability to see reporting information such as average score over time, average score across lessons, etc.

The reporting module can also provide useful information for teachers, application creators and other content providers. Existing products in the prior art such as Rosetta Stone™ do not provide facilities for contributions of content by third party vendors and do not provide reporting capabilities for such possible contributors. The reporting module 355 can include reports such as number of lessons sold, number of lessons using a specific application, amount of money earned through selling of content, etc. The reporting examples are provided here for preferred embodiments and common usage and are not for purposes of limiting the same.

As shown, the system 300 can include a comments module 360 and a rating module 370. The comments module 360 allows users of the system to add comments to different content and elements of the system. For example, a user can add comments describing the user's experience with a lesson or exercise. In another example, a user can add comments describing the user's impression of an application. In another example, a user can add comments describing system elements such as a dictionary.

The rating module 370 allows users of the system to rate the quality and usability of content, format and other elements within the system. For example, a user can rate the quality of a lesson or exercise. Comments and rating capabilities are known and exist in other products such as news web sites, online shops, and other products.

As shown, the system 300 can include an application repository. The application repository contains built-in and user provided applications for delivering educational and language content in different formats and methods. Applications can be added to the application repository during the system creation and/or through an application editor module (module 305). Applications are used in exercises and content within lessons and courses. Some applications can be used as standalone utilities such as educational games and language games. The application repository can store/persist application content and load application content in order to provide it to other system modules such as the lessons repository 335 and study module 345.

Applications, provided through the application repository module 305, define the method, format and structure used for exercises, games and other content. The applications can define the graphical user interface (GUI) representation, the type of inputs and outputs for an exercise, and the format for storing the information. For example, a doze application can define the inputs as a set of words organized in sequence and a sub-set of words to be hidden.

The application can describe the format in which to allow users to input missing words and can define a method for showing hints for words a user is having trouble filling in. The application can also contain references to system tools such as dictionaries and images. In the doze application example, the application may use a dictionary tool to provide translation for a word or phrase when a user hovers with a mouse over a word in the doze text.

As shown, the system 300 includes a lessons and courses repository module 335. The lessons repository 335 contains exercises, lessons and courses created by teachers and other content providers. The lessons repository 335 provides methods for storing and retrieving lessons and can provide means for searching, filtering and querying the system for existing content. The lessons repository 335 can interact with the application repository 340 in order to associate lessons and exercises with applications that support them for format and method. In addition, the lessons repository 335 can interact with other system modules such as rating module 370 and comments module 360. For example, lessons repository can use the rating module 370 to provide improved search and filter functionality such as finding lessons with high rating.

In certain applications, it is advantageous to students and teachers to be able to organize lessons into courses in different ways based on the needs of the student and the experience provided by the teacher. With this in mind, the lessons repository 335 provides the ability to associate lessons with courses. A lesson can be used in one or more courses. It should, nevertheless, be noted that lessons can be organized randomly or sequentially in various embodiments of the invention.

As shown, the system 300 includes a history and progress repository module 325. The history module 325 contains user specific information including lessons and courses bought and/or acquired, progress and score of lessons and exercises, dates and times of exercises and learning activities. The history module 325 allows users to stop or pause an exercise or lesson and to return to it at a later time. The history module 325 also works in collaboration with the study module 345 to provide the content available for a student. The history module 325 can be used in collaboration with the reporting module 355 to provide content for reports.

As shown, the system 300 can include a user account management module 310. The module can be used to limit and enable access to the system for specific users. The module can be used to create, edit and modify users. The module can also be used to group users into groups and and sub-groups. The user account management module 310 can work in collaboration with an access control module 315 to provide granular access controls to elements of the system and to content within the system. For example, a student can use user account module 310 in combination with the access control module 315 to allow a user acting as teacher to access the history and results of his studies.

In certain embodiments it is desirable for a student or other user to share access to the user's content with other users. In additional embodiments it is desirable for an educational platform and/or system to enable sharing of content, history, and results across users. For example, a school can provide lessons through an educational system and will need to allow teachers to review and grade students based on their results within the educational system. The access control module 315 and the user account management 310 provided here enable such sharing of data by providing the above mentioned granular access controls and flexible user accounts and grouping capabilities.

In addition, the user account management module 310 can store billing and credit information for users and user groups. Such billing information can be used for purchasing and selling lessons, courses and other content. More details regarding purchasing and billing are covered below. The user account management module 310 can also be integrated with external 3rd party user management systems including LDAP, and Active Directory (AD) for usage within organizations that have user management products (module 312).

As shown, the system 300 can include a billing module 375. The system can further interact with an external billing module 390. Billing modules such as an internal billing module 375 or an external billing module 390 allow users to use credit and other forms of payment to purchase lessons, courses and other content. In addition, such billing modules allow users to receive payment for content sold such as lessons and courses.

In the context of the foregoing, teachers, application creators and other content developers and vendors can set a price for their content, according to the properties and configuration of a particular embodiment. In addition, the system provides means for setting default pricing policies through the platform tools module 365 and the user account management 310. The system 300, will use the information stored in the lessons and courses repository 335 and other modules to calculate pricing for acquired content and will utilize the billing module 375 to charge users buying content and to pay teachers and content providers from whom content was purchased.

It should be understood that, in various embodiments, the system 300 provides a novel for-free and for-fee marketplace for educational content and language learning by combining capabilities provided by the user account management module 310, platform tools 365 and a billing module 375. It is desirable for an educational platform/system and language learning platform/system to provide a marketplace for content.

A marketplace provides incentive for teachers and content providers to create rich and varied content and provide for a student's need for rich and varied content and a wide variety of topics. The system 300, described herein, solves this need through the combination of modules provided above. It is understood that in certain circumstances, a for-free marketplace can be established without a billing module 375. For example, a corporation may establish an internal content marketplace and will encourage content creation through internal corporate policies and without the need for students to pay for content or for teachers to be paid.

As shown, the system 300 includes a platform tools module 365. The platform module provides the basic tools required to collaborate across the other system modules. The platform module provides tools such a persistence layer for loading and saving content, a dictionary for translating words and for looking up expressions. The platform module can also include tools for encrypting communications with end user systems and other such tools. The platform tools module 365 also provides the tools and techniques for loading dynamic content such as applications and lessons. In some embodiments such tools are based on existing systems such as Google™ Applications, Content Management Systems (CMS) such as Drupal™, and others. The platform tools module 365 can further interact with external tools and applications modules 385.

As shown, the system 300 can include modules for creating, editing, modifying, saving and removing of content including applications, exercises, lessons and courses. As also shown, the system 300 can include an application editor module 305, an exercise and lesson editor module 320 and a course editor module 330. These editor modules enable teachers and other content providers to extend the system and provide additional, varied and rich content.

In certain aspects, the present invention includes novel capabilities for creating and editing new content within the same tool that is used for end users, students and teachers. It is advantageous to provide the capability of creating new content, sharing it and/or selling it in order to create a marketplace with rich and varied content. Such integrated tools provide advantages over alternative arrangements in which separate tools are provided for creating content where such tools are not integrated into a system/platform that enables sharing, collaborating, selling and finding of content.

The system 300, by including such content creation modules as application 305, lesson 320, and course 330, allows for the creation of rich and varied content. This process is further fueled and extended by the interaction with the system of students who are willing to purchase and/or use the created content. It is understood that the content creation modules (305, 320, 330) can allow teachers and content providers to create new applications through a graphical user interface (GUI) and/or through a programmatic language interface (API).

As shown above, modules within the system 300 may provide persistent storage of content. Such persistent storage can include storage of content to files, and/or to a relational database and/or to other persistence forms such as XML files, and/or by other methods and techniques known in the art. Various stored information is persistently encoded by modifying the physical states of one or more computer readable media.

In certain aspects of the invention, a student enjoys access to the broader invention by use of the browser functional module 204.

The practitioner of ordinary skill in the art will understand that the arrangements presented above represent an exemplary embodiment of the invention. Of course, and as described in additional detail below, the modules and elements described in these schematic views can be provided in various subsets and arrangements within the scope of the invention. Thus in some embodiments, elements described above are omitted from the system, and additional elements can be added, all within the scope of the invention. For example, the illustrated billing module 375 can be omitted according to the needs of a particular application.

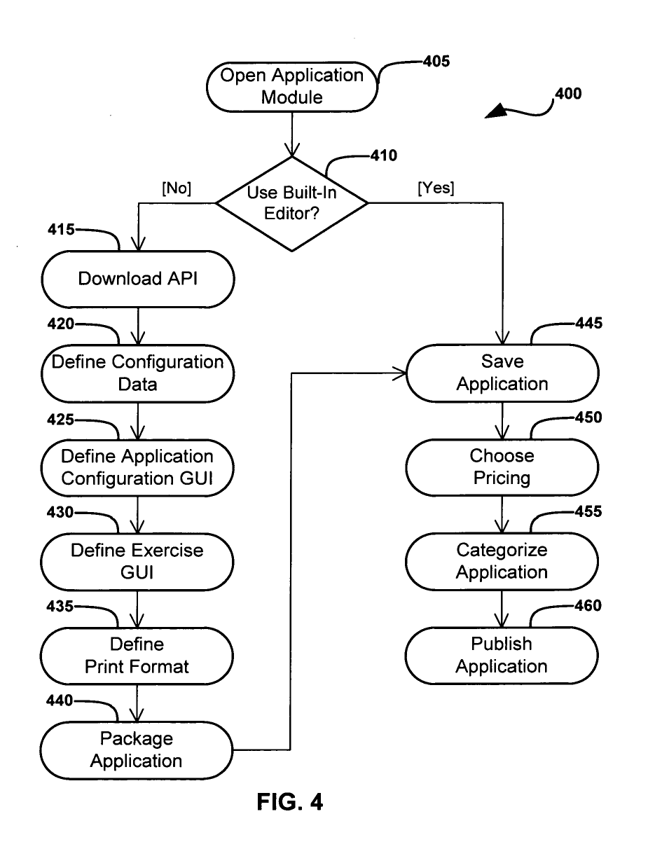

The operation and interaction of the exemplary modules and features of the invention heretofore presented will now be further described with reference to FIGS. 1-3 and to the following figures. Accordingly, FIGS. 4-12 illustrate, in overview the creation of application, the creation of a particular lesson, the creation of a course, the execution of a lesson, the purchase of pedagogical content, the extension of the underlying platform, off-line operation, the printing of various material generally and the printing of reports in particular.

FIG. 4 shows, in flow chart format, an overview of an application creation process and method 400. While the process of FIG. 4 is contemplated in the context of the above-described apparatus and systems, one of skill in the art will appreciate that alternative apparatus and systems may be employed within the scope of the invention. As shown, the method 400 is initiated at step 405 with input by a content developer to open the application editor module 305 (FIG. 3). At step 410 the developer is provided with option to create or edit an application using a built-in editor or to use an extrinsic application programming interface (API). If the developer chooses to not use the built-in editor, the developer follows a sequence of steps described in steps 415 to 440.

At step 415 the developer downloads the application editing API, or uses a previously downloaded API. Using the API 220, the developer defines configuration data required for the application. The configuration data defines the data that is required for an application and for an exercise and/or game that uses the application. In certain embodiments of the invention, the configuration data definition includes a format in which the data is stored and retrieved through the system. For example, in a multiple-answer application, the configuration data can be defined to have a variable-size array of sentences representing questions, with each question associated to variable-size array of sentences representing the multiple answers and a single sentence for the correct answer.

After the developer defines the configuration data, he or she can define the graphical interface for the application. This includes defining 425 the graphical interface used by teachers and/or content providers for configuring an exercise and/or game that uses the application as well as defining 430 the graphical interface employed when a student uses an exercise and/or game during a lesson or course.

In one embodiment, the developer also defines a print format 435 for printing an application. The printed application can be used off-line by a student or teacher after printing. As a final step for creating an application, the developer packages the different elements of the application and uploads them into the system. It is understood that the developer can iterate through the different steps 420 to 440 to continuously refine and improve the application.

The built-in editor offers substantially the same process steps as the extrinsic procedure. The developer is provided with built-in tools for data definition and graphical user interface creation. After creating and/or editing the application, the developer saves the application including changes 445. Thereafter, as illustrated, the developer chooses pricing for the application 450. Depending on the business model adopted, a developer may provide the application free or for a fee. In certain embodiments, the developer can adopt a system default pricing model.

The developer can categorize the application by topic, study area, keywords, difficulty level, and other categorization parameters provided by the system 455. The application categorization will be used by other developers, as well as by teachers and students when searching the application repository 340 (FIG. 3) of the system. When the application is ready for consumption by others, the developer publishes the application 460. According to certain embodiments of the invention, a developer retains the ability to withdraw from publication an application that has been previously published.

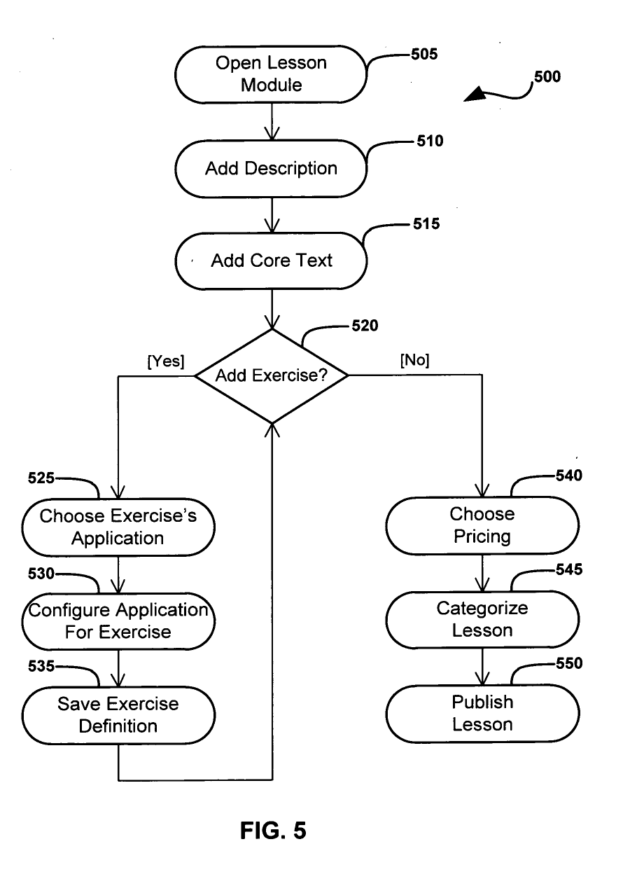

FIG. 5 shows a flowchart illustrating a further aspect of the invention including a method and process for the creation of lesson content. As shown, the method 500 is initiated when a developer opens 505 the lessons editor module 320. In one aspect of the invention, the developer enters general information and a description of the lesson 510. In certain embodiments, the entry of general information and description information is optional. The developer can also add free form text and notes to the lesson 515.

As illustrated, the process offers iterative steps controlled by a decision 520 that allows a developer to add any desired number of exercises to the lesson. The developer is provided with several steps to configure each exercise as it is added to the lesson. For example, the developer chooses the application that supports the exercise 525. The developer then configures the exercise based on the configuration data and on the graphical user interface conventions of the application 530. When creating an exercise based on a multiple-answer application, for example, the developer creates questions for the exercise and provides possible answers including the correct answer. The developer thereafter saves any changes to the exercise 535.

In the illustrated embodiment, the developer has the ability to choose pricing for a lesson based on system policies and defaults and on the desired price of the developer creating the lesson 540. The developer can categorize the lesson by topic, study area, keywords, difficulty level, and other categorization parameters provided by the system 545. The lesson categorization will be used by the developer and by other users of the system when searching the lessons repository 335 of the system.

When the lesson is ready for consumption by others, the developer publishes the lesson 550. In certain embodiments, the developer can also withdraw a lesson that has been previously published from publication.

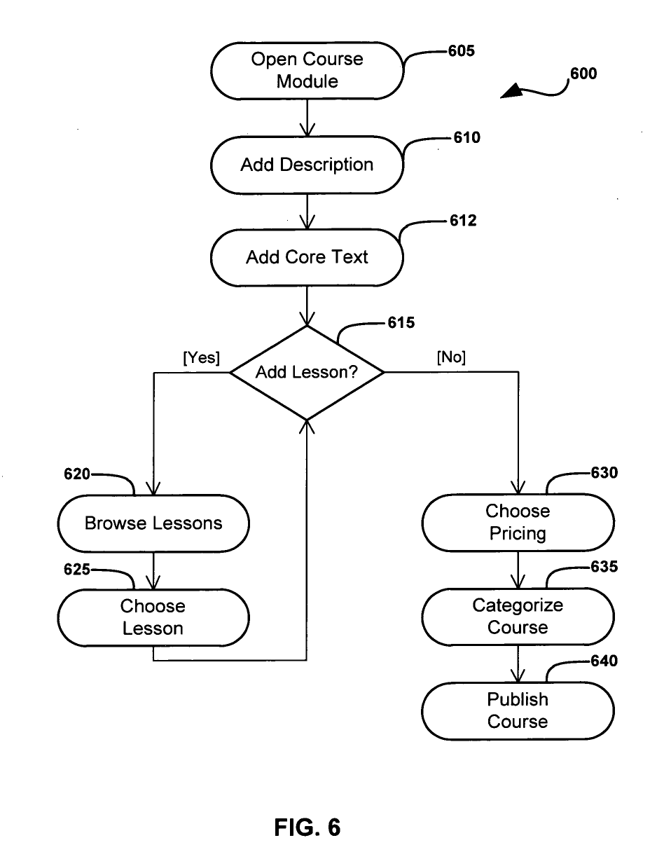

FIG. 6 shows, in flowchart form, a process and method for creating a course according to principles of the invention 600. As shown, the method 600 is initiated with input by the developer to open 605 the courses editor module 330. In one illustrated aspect of the invention, the developer enters general and descriptive information for the course 610. In other embodiments of the invention, the entry of general and descriptive information is optional.

As illustrated, the process offers iterative steps controlled by a decision 615 that allows the developer to add as many lessons to the course as necessary or desired. The developer browses available lessons 620 in order to find a lesson that should be added to the. The developer then chooses and adds the lesson to the course 625. In certain embodiments, the developer is provided with additional steps (not shown) that allow detailed configuration of a lesson as it is added to the course.

As shown, the developer can, in certain embodiments, choose the pricing for a course 630. According to the particular implementation of the invention, the choice of pricing is based on one or more of system policies, defaults and judgment of the developer.

Also, as shown, the developer can categorize the course by topic, study area, keywords, difficulty level, and other categorization parameters provided by the system 635. The course categorization is available for use by the developer and other users of the system when searching the lessons & courses repository of the system 335. When the course is ready for consumption by others, the developer publishes the course 640. As with applications and lessons, in certain embodiments, the developer can withdraw from publication a previously published course module.

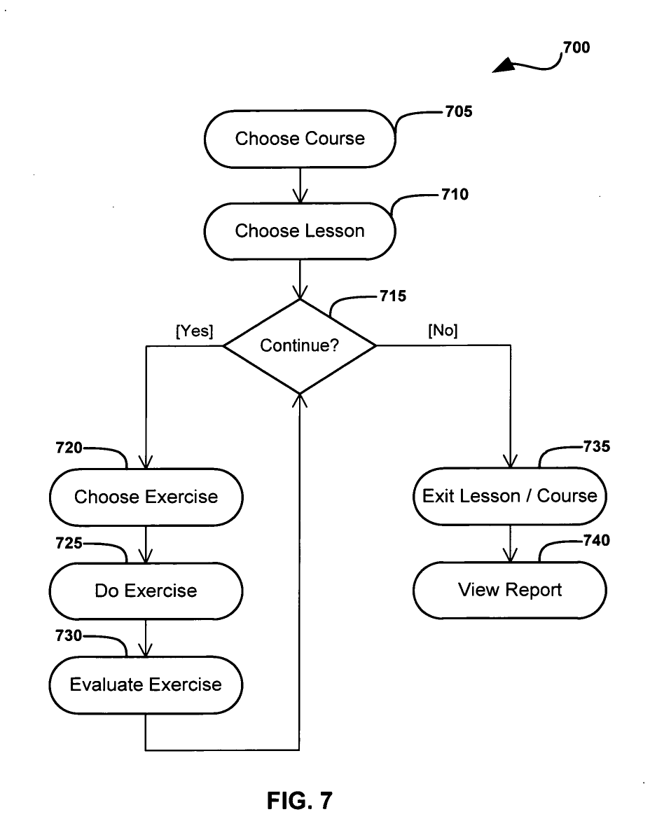

FIG. 7 shows, in flowchart format, a process and method by which a consumer such as a student or teacher can select and use a lesson or course 700. It should be understood that, the term “student” is used generically herein to represent various consumers including students, teachers, and others. Accordingly, the method 700 is initiated with input from a student (or teacher) received at the student study module 345. In the illustrated method, the student chooses a course 705 and chooses a lesson 710. In alternative process embodiments, the student directly chooses a lesson that is not associated with any course 710.

In certain aspects of the invention, information indicating the student's progress in completing the lesson is stored on a regular basis. Such storage is effected by encoding data onto a device through a physical transformation of a machine readable medium. In certain embodiments, the saving of information can be initiated by one or more of student action and system action. Thereafter, when resuming a previously studied lesson, the student can continue from the point and state where the student previously stopped. Alternately, the student can elect to reset the lesson and start it from the beginning.

When taking a lesson, the student can decide 715 to continue studying or to stop studying. When studying a lesson, the student chooses an exercise within the lesson 720. The student and executes the exercise 725. In certain aspects of the invention, the system provides feedback to the student regarding his or her progress in completing the exercise 730. Such feedback can be provided during and/or after the exercise according to the details of a particular embodiment.

When the student has finished a lesson, or when the student decides to stop or pause the lesson, he or she chooses to exit the lesson/course 735. The student can then view a summary of his or her progress in completing the exercises, lessons and/or courses 740.

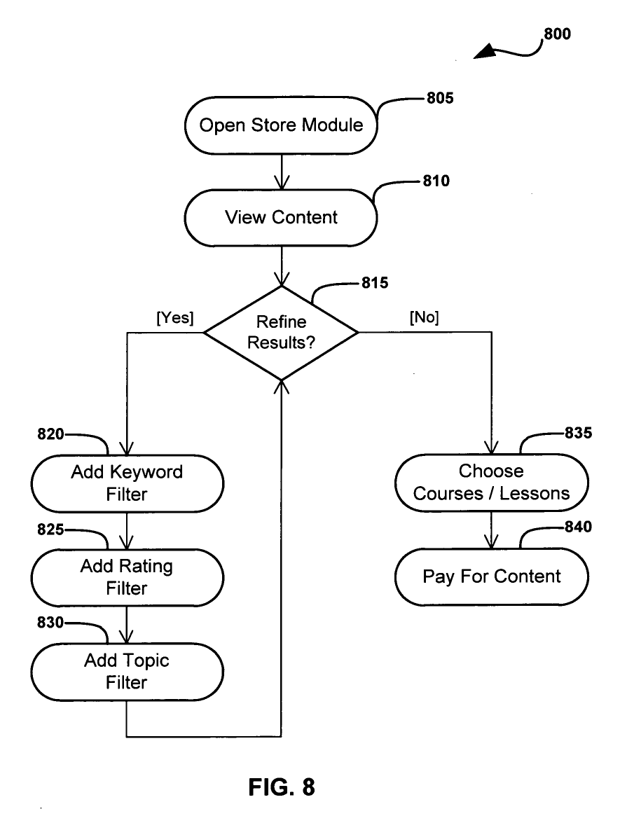

FIG. 8 shows, in flowchart form, a process and method for purchasing or otherwise securing a lesson or course according to principles of the invention 800. As shown, the method 800 is initiated with input from a student (or teacher) received 805 at a store module functions portion of the system. In certain embodiments, the store module is a subset of the lessons and courses repository module 335. After opening the store module, the student views the contents of the lessons and courses repository 810.

According to certain embodiments of the invention, content displayed to the user is pre-filtered by the system based on information stored in the user account management module 310 and access control module 315 as well as through system policies defined in the platform tools module 365. According to the exemplary method illustrated, the student has an option to further refine the search results 815. When this option is elected, the student enters keywords for searching content 820. The illustrated embodiment also offers the opportunity to filter content based on rating 825 and based on topic and/or study area 830. As shown, the student can continue to refine the filtering criteria in iterative fashion by adding and combining different rules together.

Once the selection of course materials presented has been refined to a desired level, the student selects a specific course and/or lesson 835. Depending on pricing information for specific courses and lessons and based on system policies, the user may be required to pay for some or all of the content selected. The exemplary method illustrated shows payment for content 840.

Content acquired, for free or for consideration, by the student will be available for usage through the user's lesson and courses history and progress module 325. The student can remove lessons and courses based on system policies. For example, a system configuration can allow a student to return content that has been purchased, but not used yet, for a refund. A user is billed by the system based on the selection of lessons and courses, as reported to the billing module 375. According to the configuration of a particular system, and optional external billing module 390 provides additional billing services, and information stored in the user account management module 312.

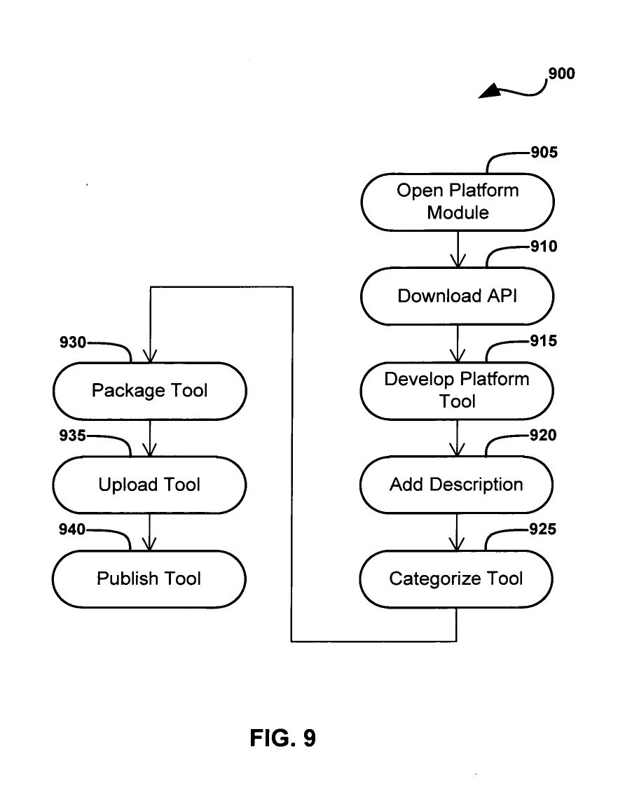

FIG. 9 shows, in flowchart form, a process and method for extending the pedagogical platform of the invention 900 using the platform tools module 365. Platform tools module 365 incorporates novel tools and methods along with conventional tools and methods configured and disposed in novel combinations and adapted to provide techniques for platform extension. One example of an extendable platform is the open source Eclipse project.

As shown, the method 900 is initiated by receiving input from a developer 905 through the platform tools module 365. According to the illustrated exemplary method, the developer downloads 910 the platform API. Using the platform API, the developer then develops a new platform tool (or prepares an extension of an existing platform tool) 915. Thereafter, in the illustrated method, the developer adds a description and general information 920 about newly developed or extended platform tool.

In the illustrated embodiment, the developer categorizes the platform tool by topic, keywords, system object applicability (exercise, lesson, course, etc.) and other categorization parameters provided by the system 925. This platform tool categorization is subsequently used by the developer and/or other users of the system when building content such as applications, lessons and courses and through general usage of the system such as games, dictionaries and other standalone operations.

Thereafter, the developer packages the new or edited tool 930 and uploads the tool 935 into the system. Thereafter, when the tool or other platform extension is ready for deployment to other users, the tool creator/editor can publish the tool 940. In certain embodiments, the developer can withdraw a tool, platform or platform extension that has been previously published from publication.

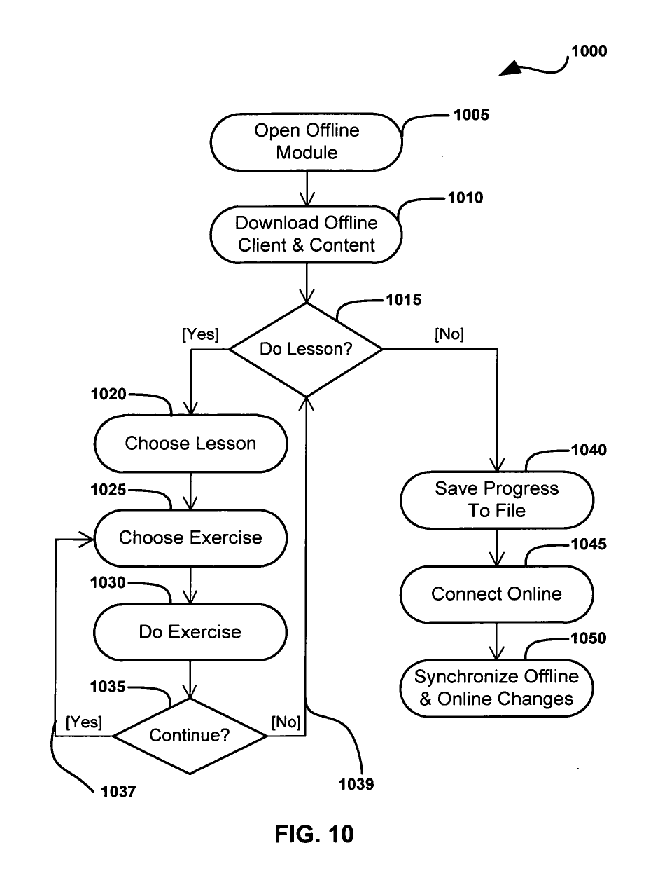

FIG. 10 shows a flowchart illustrating a process and method for off-line execution 1000 of various pedagogical products and content available to a student or other consumer according to principles of the invention. In certain aspects of the invention off-line execution is further available to system developers and others. In certain aspects of the invention, such off-line execution is effected and/or facilitated by an off-line module.

During off-line operation, a student (or other consumer) can execute certain system functions in the absence of access to the Internet, wide area network (WAN) or local area network (LAN). In certain embodiments of the invention, off-line operation is the default mode when the functionality of a client device 104 and a server apparatus 102 are disposed and operating within a common computerized apparatus.

In certain invention embodiments, the system is configured to have the user system, exemplified by client device 104, separated from the server system 102. In such a configuration, the user primary storage is within the server system 102. In such circumstances, it is desirable to allow a user to work in an offline mode. An exemplary method and technique for doing so is described herein.

As shown, the method 1000 is initiated by receiving input from a user, such as a student, through the student study module 345 to open the off-line module 1005. In the illustrated embodiment, the user downloads an offline compatible client and the latest content that is relevant to the user 1010. In other embodiments, such downloading is optional.

According to certain aspects of the invention, the user uses the offline client to continue previously initiated work on a previously acquired and received lesson or course. The user can also choose to take a lesson or pause progress and save an existing system state by making a selection 1015.

In the illustrated example, the student is prompted to choose a lesson for studying 1020. The student then chooses an exercise 1025 and executes the exercise 1030. Upon completion of the exercise, the student can optionally 1035 continue with other exercises of the selected lesson 1037 or choose a different lesson or exit 1039.

Progress made by the student is encoded and received for storage at a local storage component, including a file and/or local relational database 1040. When desired and/or possible, the user can reconnect 1045 to the server system 302 in order to synchronize the progress made while offline 1050. The user system 202 will synchronize the progress and changes made offline with any changes and progress that has been made online.

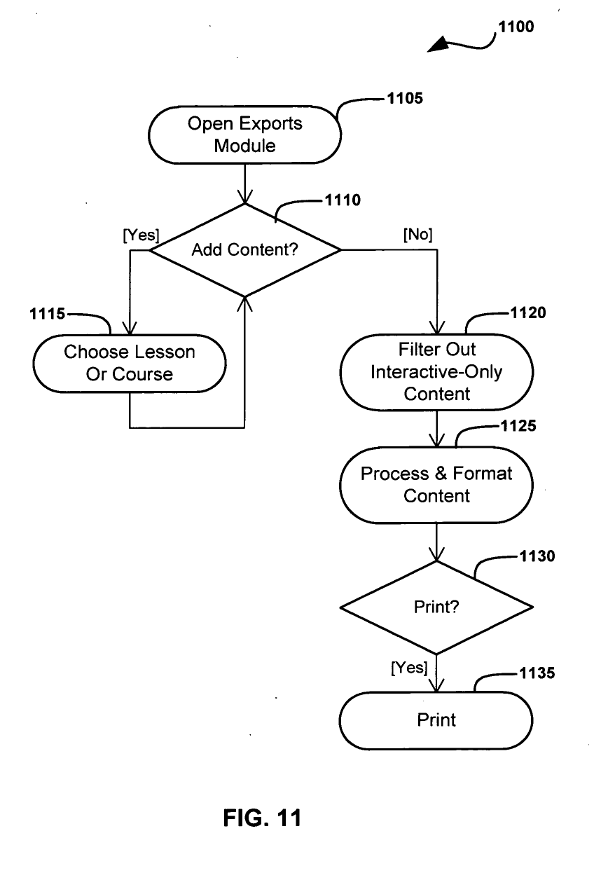

FIG. 11 includes a flowchart illustrating further aspects of the invention including a process and method 1100 to effect certain printing functions for the printing of educational material and pedagogical content. It is desirable for students and teachers to be able to print educational material and language learning content. Students and teachers want to print content for non-interactive usage. For example, a teacher may want to print language exercises for usage when no computerized apparatus is available for the teacher's students.

In certain embodiments, a system according to the invention provides printing facilities as is shown in FIG. 11. In one aspect of the invention, the printing method 1100 is initiated 1105 by input received from a user through the student study module 345. In another aspect of the invention, printing is initiated by a user command received through the lessons and courses repository module 335.

As illustrated, a user indicates a desire to choose content for printing 1110. In certain embodiments, the user can add any number of content elements (lessons, courses, etc.). The system provides the user the ability to choose content 1115 from the content that is available to the user through the lessons and courses module 335. Some content may be available for interactive usage only and will be filtered out by the system 1120. The system will process the selected content and format it for printing 1125.

In certain processes according to the invention, the system selects and applies print format definitions based on general policies stored in the platform tools module 365 as well as definitions provided by application creators, as discussed above. The system can ask the user to confirm the print operation 1130 and then send the formatted material to a printing capable device 1135 including, for example, printers, and PDF files.

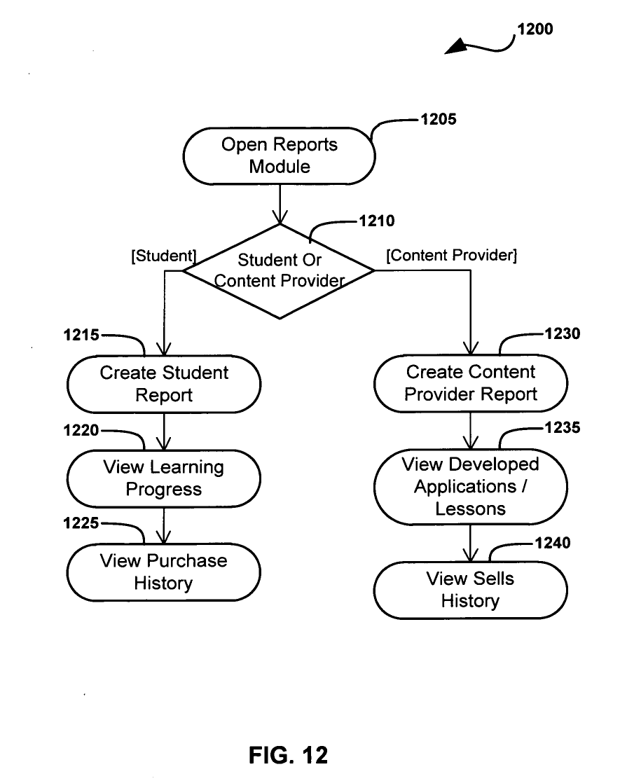

FIG. 12 shows a flowchart illustrating certain progress report functionality including a report method and system 1200 according to principles of the invention. As shown, the method 1200 is initiated when input is received from a particular user 1205. It should be noted that the user, in a particular cycle of the system can be, for example, a student or a content provider. Other uses are also contemplated, including teachers and system managers.

According to the illustrated embodiment, the user chooses a report type 1210. One illustrated report modality provides a student oriented report. Another illustrated report modality provides a content provider oriented report. The illustrated system is adapted to receive a user input to control selection of options and configurations for the desired report type. Thus according to a selection at step 1210 a student report is prepared 1215 or a content provider report is prepared 1230.

The system will process the inputs provided by the user and will create the desired report using the data, progress and status stored in the system's different modules including the lessons and courses module 335, the users history and progress module 325 and the tools and extensions in the platform tools module 365. The user can then view the correspondingly prepared report.

A student can view his or her lessons and courses status and progress 1220. A student can also view his or her purchase history 1225. A teacher or content provider can view a report of all the content that was developed (applications, exercises, lessons, courses, games) 1235. A teacher or content provider can also view usage of their lessons and corresponding sales history 1240. Additional information can be provided in the reports module through built-in functions as well as platform tools extensions according to the specifications and requirements of a particular application or embodiment of the invention.

The foregoing having provided an overview of the apparatus and methods of the present invention, reference is now had to further detailed description relating to certain aspects of further embodiments of the invention. In particular, additional system functionality is represented which, together with the foregoing, will allow the practitioner of ordinary skill in the art to prepare all embodiments of the invention without undue experimentation.

The skilled practitioner will readily understand that the functions illustrated schematically here are intended to be encoded in particular machine readable media and devices so as to constitute, in conjunction with corresponding computing devices and machinery, particular and specialized apparatus effective to perform the disclosed functions. It is important to note the devices and machinery, and corresponding functionality, is understood to be widely distributed, both spatially and logically, in certain embodiments of the invention. Thus the functionality described throughout this disclosure is understood to be encoded in any of the devices illustrated in FIG. 1, and in any other appropriate devices and apparatus.

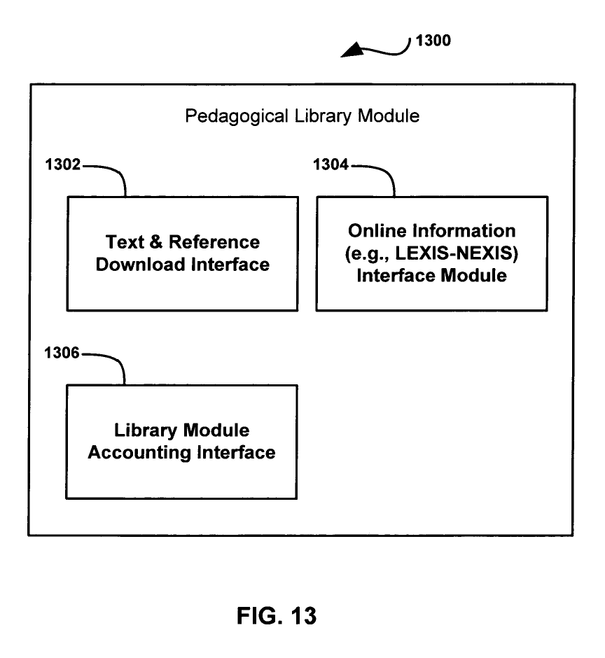

In particular, certain functional modules are well adapted to be disposed within a server device, within a client device, or within a distributed embodiment of a server or client device as in, for example, a cloud configuration. FIG. 13 shows one such functional module in the form of a pedagogical library module 1300.

The pedagogical library module 1300 illustrated here has exemplary functions including a text and reference download interface 1302, an online information interface 1304 and a library module accounting interface 1306. In various embodiments of the invention, the pedagogical reference download interface 1302 provides access to an intrinsic database of stored reference materials related to the various pedagogical presentations available within the system of the invention. In other embodiments of the invention, the pedagogical reference download interface 1302 provides an interface to extrinsic reference materials including, for example, online libraries. Accordingly, in certain exemplary embodiments of the invention, the reference download interface 1302 provides access to Google Books™.

As illustrated, the pedagogical library module 1300 also provides access to online information databases such as, for example, LEXIS-NEXIS™ and other online resources. In addition, the pedagogical library module 1300 includes an accounting interface 1306 adapted to provide cost information related to the use of various online resources to a general accounting function of the system. In certain embodiments of the system, the accounting interface 1306 is adapted to relate particular expenditures to the activities of a particular student, teacher, developer, or other user.

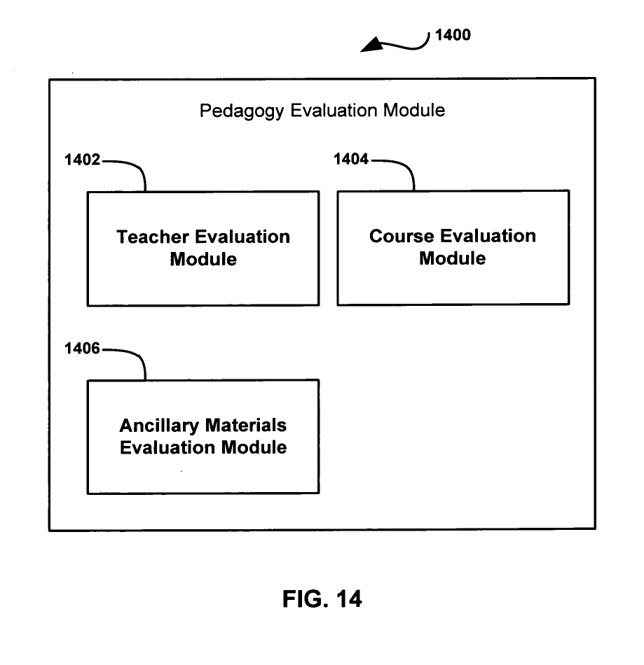

FIG. 14 shows an exemplary pedagogy evaluation module 1400 according to a further aspect of the invention. The pedagogy evaluation module is adapted to present a user interface including, for example, one or more screens to an evaluator such as a student, a teacher, a manager, or an independent evaluator. In its various aspects, the pedagogy evaluation module presents screens for displaying information and receiving information related to the evaluation of a teacher 1402, evaluation of a course 1404 and evaluation of ancillary materials 1406.

In the context of the foregoing disclosure one of skill in the art will readily understand that the evaluation module 1400 can be extrapolated to include evaluation of particular lessons, evaluation of examination materials, evaluation of the invention system as a whole, or evaluation of any other feature of the pedagogical presentation.

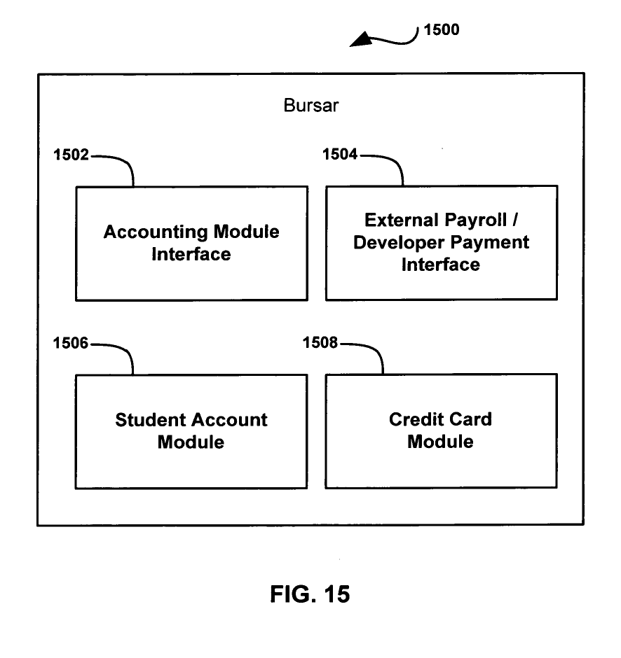

FIG. 15 shows an exemplary bursar module 1500. The bursar module includes an accounting module as previously described including an accounting module interface 1502. In addition, the bursar module includes an interface adapted to control external payroll and developer payment 1504. The bursar module further provides a student account module 1506 adapted to maintain a consolidated record of student expenditures within the system. Consistent with receiving payments from students and other system participants, the bursar module 1500 includes a credit card interface module 1508. These and other functions of the bursar module provide a coherent accounting and bookkeeping system for the system of the invention as a whole.

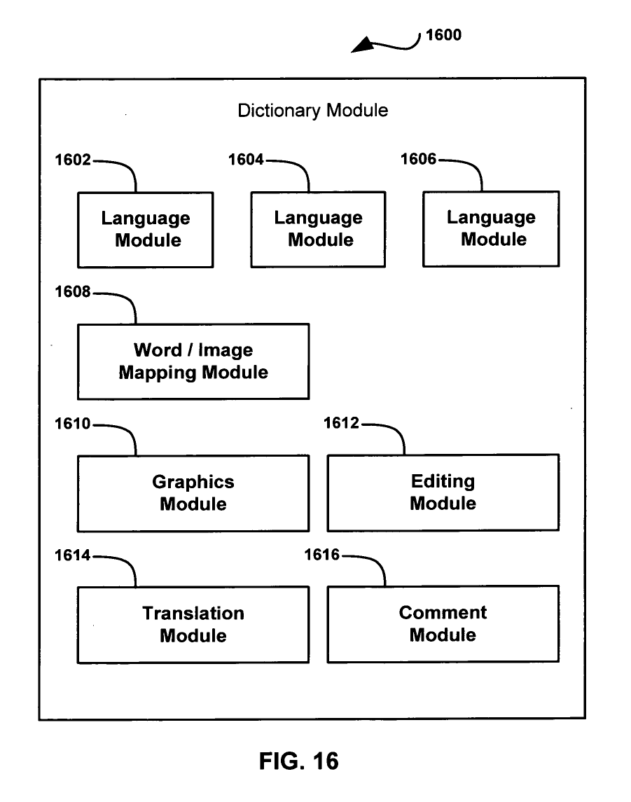

FIG. 16 illustrates, in block diagram form, a dictionary module 1600 included in certain embodiments of the invention. In the exemplary embodiment illustrated, the dictionary module 1600 is adapted to provide data storage and interface functionality to provide access to a plurality of language dictionaries. Accordingly, a first language module 1602 is provided to support a first language functionality (such as, e.g., French). A second language module 1604 is provided to support a second language functionality and a third language module 1606 is provided to support a third language functionality.

According to certain embodiments of the invention, the dictionary module includes a word/image mapping module 1608. The word/image mapping'module is adapted to provide a relational mapping between words and/or other elements of the language modules 1602, 1604, 1606 and a database of graphical images or other multimedia content (such as, e.g., audio clips, video clips, olfactory clips, etc.).

In certain embodiments of the invention, the dictionary module includes an intrinsic graphics module 1610 adapted to store and display various images or other content responsive to an action of the word/image mapping module 1608. In certain embodiments of the invention, the graphics module 1610 includes editing facilities, available in an editing module 1612, adapted to allow a user, such as a content developer, a teacher or a student, to edit a data element relationship of the word/image mapping module 1608. According to certain aspects of the invention, the editing module 1612 includes intrinsic permissions controls for the management of such editing. In other embodiments, permissions controls are provided in a separate extrinsic module.

In a further aspect of the dictionary module 1600, according to certain embodiments of the invention, a translation module 1614 is provided. In certain embodiments, the translation module includes an intrinsic translation engine adapted to provide a relational mapping between words and/or other elements of the language modules 1602, 1604, 1606. In still further embodiments of the invention, the translation module includes an interface device adapted to couple the system of the invention to an external translation functionality. Accordingly, in certain embodiments of the invention, the translation module includes an interface adapted to couple the system of the invention to a translation facility such as Google Translate™ or Babelfish™.

In a further aspect, the dictionary module 1600 includes a comment module 1616. The comment module 1616 is adapted to receive, store and organize a variety of comments and other feedback from various uses of the dictionary module. Thus, the comment module 1616 may receive feedback comments related to system performance and other topics from content developers, teachers, students, and others.

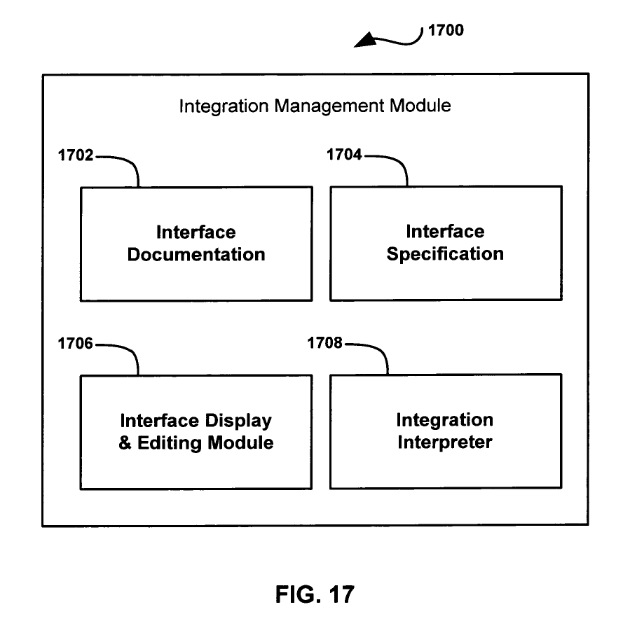

As will be understood by one of skill in the art, the ability to provide a consistent interface across pedagogical content provided by a wide variety of contributors and developers is advantageously addressed by having an integration management module. FIG. 17 illustrates, in schematic block diagram form, exemplary features available according to certain aspects of an integration management module 1700.

In certain embodiments of the invention, the integration management module 1700 includes an interface documentation module 1702. The interface documentation module provides organized access to a documentation set including a functional specification for the system user interface 1704. In addition, the interface documentation module, in certain embodiments, includes enforcement mechanisms adapted to ensure that various aspects of the functional specification, and the corresponding interface characteristics, are adhered to by content developers and other contributors.

Accordingly, in one aspect of the illustrated embodiment, the integration management module 1700 includes an interface display and editing module 1706 providing input and editing facilities for use by content developers and others. In a further aspect, the integration management module 1700 includes an integration interpreter 1708. The integration interpreter 1708 is adapted to receive the encoded information representing an interface under development from the interface display and editing module. The integration interpreter 1708 evaluates, and in some cases modifies the encoded information to ensure compliance of the encoded interface with the interface specification 1704.

While the exemplary embodiments described above have been chosen primarily from the field of language pedagogy, one of skill in the art will appreciate that the principles of the invention are equally well applied, and that the benefits of the present invention are equally well realized in a wide variety of other communications and teaching systems including, for example, mathematics pedagogy systems, literature pedagogy systems, technical reference systems and other information handling systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A pedagogical exchange system comprising:
a student user interface machine, said student user interface machine being adapted to receive from a remote storage device a previously prepared pedagogical presentation, said pedagogical presentation being received responsive to a student selection, said pedagogical presentation being selected from a plurality of possible pedagogical presentations;
a storage machine, said storage machine including said remote storage device, said storage machine being adapted to store and reproduce an encoded portion of said pedagogical presentation, said storage machine being adapted to receive and store, from a respective plurality of independent developers, respective encoded portions of said plurality of possible pedagogical presentations;
a management system, said management system including said storage machine, said management system being adapted to configure a machine readable medium of said storage machine to represent an encoded record related to said student selection;
wherein said user interface machine and said storage machine each includes a respective programmable processing device and a respective memory device, said memory devices being adapted to undergo a measurable transformative reconfiguration so as to represent an encoded portion of said pedagogical presentation as a measurable physical state of said memory device.

2. A pedagogical exchange system as defined in claim 1 wherein said storage machine comprises a single storage machine.

3. A pedagogical exchange system as defined in claim 1 wherein said storage machine comprises a plurality of storage machines disposed remotely with respect to one another

4. A pedagogical exchange system as defined in claim 3 wherein said plurality of independent developers comprises at least one corporate legal entity.

5. A pedagogical exchange system as defined in claim 1 wherein said plurality of independent developers comprises at least two distinct legal entities.

6. A pedagogical exchange system as defined in claim 1 wherein said encoded record comprises encoded data representing a history of pedagogical presentations selected by said student.

7. A pedagogical exchange system as defined in claim 1 wherein said encoded record comprises encoded data representing a history of learning performance exhibited by said student.

8. A special purpose pedagogical processing machine comprising:
a processor;
a memory unit;
a communications device; and
a storage device including a computer readable medium, said computer readable medium including a plurality of switching structures, said plurality of switching structures being switched to encode pedagogical information from a plurality of independent information developers.

9. A special purpose pedagogical processing machine as defined in claim 8 wherein said pedagogical information comprises language-teaching information.

10. A special purpose pedagogical processing machine as defined in claim 9 wherein said language-teaching information comprises information for teaching a language selected from the group consisting of English, French, German, Italian, Spanish, Portuguese, Russian, Hebrew, Arabic, Mandarin, Cantonese and Japanese.

11. A special purpose pedagogical processing machine as defined in claim 8 wherein said storage device is adapted to receive pedagogical information from a plurality of content developers.

12. A method of presenting a lesson comprising:
receiving lesson information at a lesson storage machine from a lesson developer;
receiving a lesson offer from said lesson storage machine at a student interface machine;
receiving a lesson acceptance from said student interface machine at said lesson storage machine;
receiving said lesson information from said lesson storage machine at said student interface machine; and
responsively crediting said lesson developer with consideration for said receipt of said lesson information at said lesson storage machine.

13. A method of presenting a lesson as defined in claim 12 wherein said receiving said lesson offer comprises receiving an offer of said lesson information and further lesson information from a further lesson developer, said further lesson developer being independent of said lesson developer.

14. A method of presenting a lesson as defined in claim 12 wherein said lesson information comprises language lesson information.

15. A method of presenting a lesson as defined in claim 12 wherein said lesson information comprises mathematics lesson information.

16. A method of presenting a lesson as defined in claim 12 further comprising:
receiving a substantial student input from said student at said student interface machine; and
assessing a student learning level based on said substantial student input.

17. A method of presenting a lesson as defined in claim 12 wherein said assessing a student learning level comprises evaluating said substantial student input to form an evaluation record and storing said evaluation record at said lesson storage machine.

18. A method of presenting a lesson as defined in claim 12 further comprising receiving said lesson information at a developer interface machine; and
organizing said lesson information according to a developer rule, said developer rule being the stored on a machine readable storage medium associated with said developer interface machine.

19. A method of presenting a lesson as defined in claim 12 further comprising storing said lesson information at said student interface after receiving said lesson information and prior to review of said lesson information by a student.
